(19) United States
(12) Patent Application Publication
(10) Pub. No.: US 2009/0218952 A1
(43) Pub. Date: Sep. 3, 2009

(54) COLOR-CHANGING LIGHT STRING

(76) Inventor: Tai-Ning Tang, Honolulu, HI (US)

Correspondence Address: EGBERT LAW OFFICES, 412 MAIN STREET, 7TH FLOOR, HOUSTON, TX, 77002, US

(21) Appl. No.: 12/041,313

(22) Filed: Mar. 3, 2008

(51) Int. Cl. H05B 37/00

(52) U.S. Cl. 315/185 R

(57) ABSTRACT

A color-changing light string comprises a plurality of color-changing luminous bodies connected in series, driven by a rectifier circuit and controlled by a control switch, so that each of the luminous bodies in the light string can emit lights of various colors individually, making the entire light string sparkle with vibrant and different colors and effectively enhancing visual effects of the light string as is not seen in conventional light strings.

### BACKGROUND OF THE INVENTION

1. Technical Field

The present invention relates to a color-changing light string, and more particularly, to a light string structure comprising a plurality of color-changing luminous bodies connected in series, driven by a rectifier circuit and controlled by a control switch, wherein each of the luminous bodies has a transparent enclosure housing therein a plurality of micro light-emitting diodes (LEDs) having different colors and very small volumes, a variable resistor, and an integrated circuit (IC) for light-on/light-off control. The light-on/light-off control IC in each of the color-changing luminous bodies is driven by the rectifier circuit and controlled by the control switch to control each of the micro LEDs in each said color-changing luminous body, so that the micro LEDs are turned on and off alternately to make each said color-changing luminous body emit flickering lights of various colors. Thus, the entire light string produces a brilliant and colorful visual effect.

2. Description of Related Art

A light string is generally composed of a plurality of light bulbs in series connection, wherein light bulbs of different colors are integrated into the light string while controlled and driven by a control IC, so that the light bulbs of different colors in the light string are alternately turned on and off, individually or in groups. Such light strings are usually applied to indoor walls, windowsills or other decorations (such as a Christmas tree) to create a dazzling effect and a happy atmosphere in parties or on birthdays and other festive occasions. However, most of the conventional light strings use traditional light bulbs, which not only consume more electricity but also generate a high heat. In other words, these light bulbs are uneconomical and will easily burn out. In recent years, with the invention of LED, there is a trend that traditional light bulbs are gradually replaced by LEDs, which not only save electricity but also generate a lower heat. In the field of light strings, there have also been products stringed with LEDs. However, be it a traditional light bulb or LED, each of the lights in a light string can at most produce one color. If a colorful lighting effect is desired of a light string, a variety of light bulbs or LEDs having different colors must be carefully organized, planned and integrated with a control IC, so that the light bulbs or LEDs having different colors are turned on and off alternately. Nevertheless, such conventional light strings can at most twinkle with the predetermined colors of individual light bulbs or LEDs, providing a changing and yet monotonous lighting effect and leaving room for improvement.

### SUMMARY OF THE INVENTION

In view of the fact that each of the light bulbs or LEDs in a conventional light string can emit light of only one color so as to generate limited lighting effects, the inventor of the present invention applied his ample experience in researching, developing and manufacturing relevant products to the improvement of conventional light strings, and after a complete R&D process of planning, trial production, testing and modification, finally succeeded in developing a color-changing light string that has been actually made and test-proven to produce excellent results. The color-changing light string according to the present invention comprises a plurality of color-changing luminous bodies connected in series, driven by a rectifier circuit and controlled by a control switch, so that the individual luminous bodies in the light string can each emit light of different colors, thereby providing the entire light string with vibrant and changing colors, greatly enhancing visual effects and contributing to better atmosphere creation.

### BRIEF DESCRIPTION OF THE DRAWINGS

The structure and effects of the present invention will be best understood by viewing the following detailed description of preferred embodiments in conjunction with the accompanying drawings, in which:

FIG. 1 is a schematic view of a circuit of a color-changing light string according to the present invention;

FIG. 2 is a schematic view of a general structure of the color-changing light string according to the present invention; and

FIG. 3 is a schematic, partial structural drawing of a color-changing luminous body in the color-changing light string according to the present invention.

### DETAILED DESCRIPTION OF THE PREFERRED EMBODIMENT

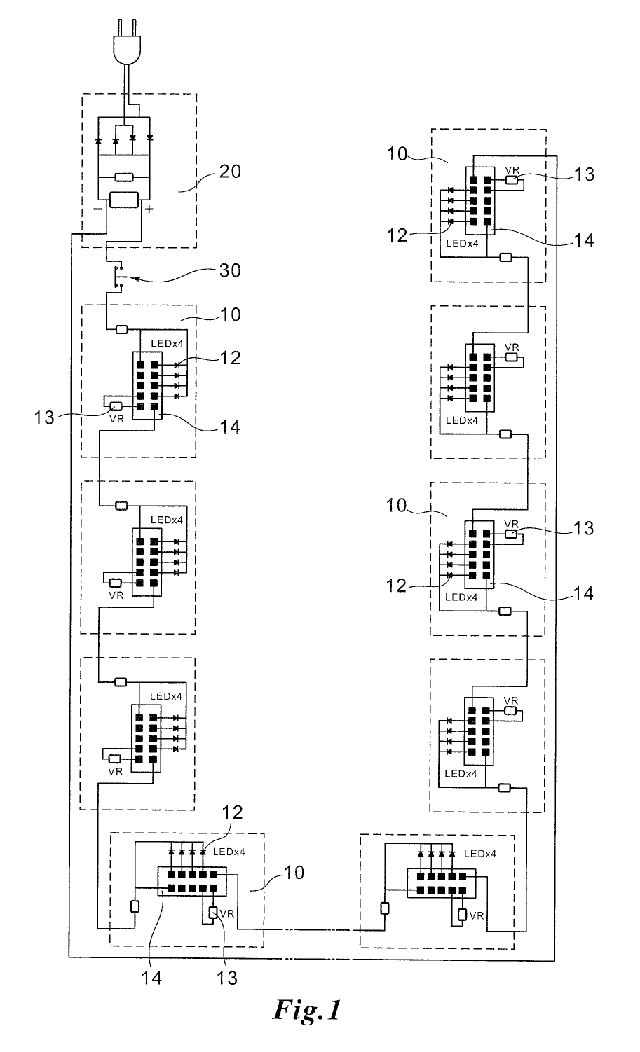

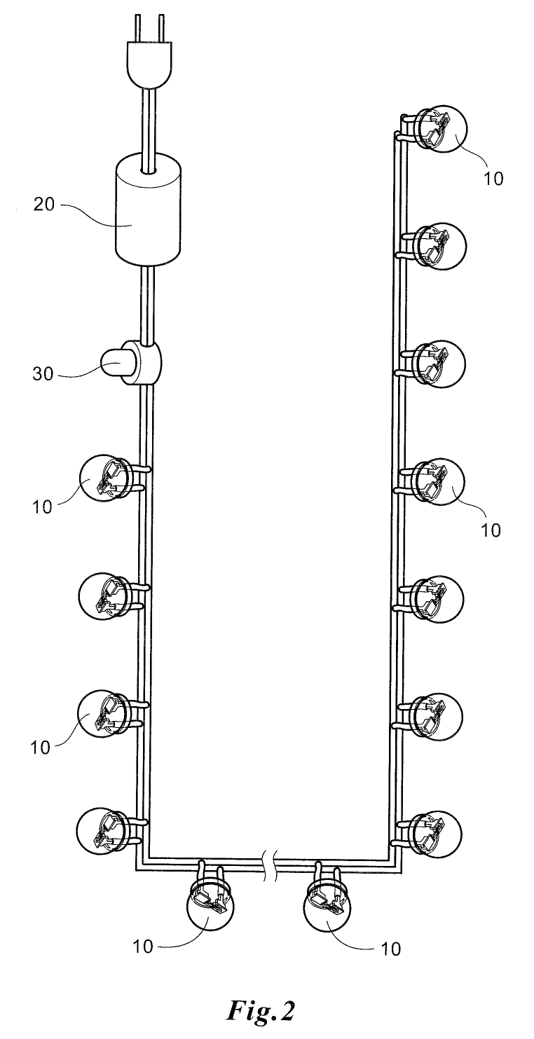

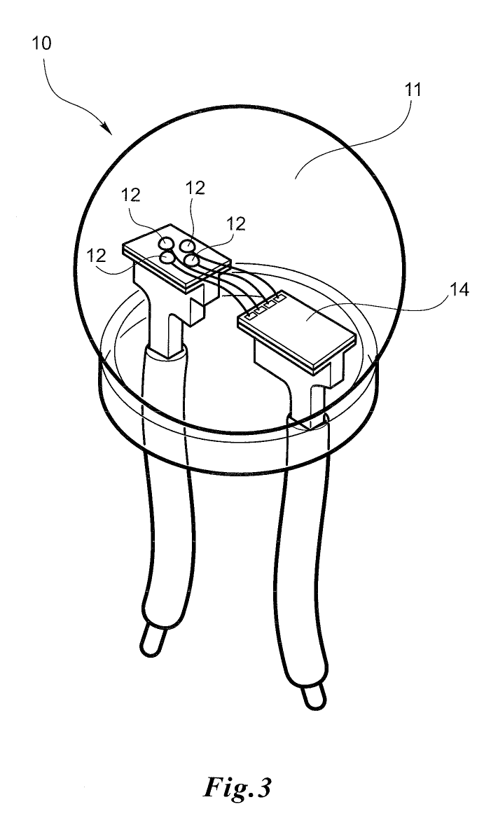

Referring to FIGS. 1 to 3, a color-changing light string according to the present invention comprises in series connection a plurality of color-changing luminous bodies 10, a rectifier circuit 20 and a control switch 30, wherein each of the luminous bodies 10 has a transparent enclosure 11 of a similar size in which a plurality of micro LEDs 12 having various colors, a variable resistor 13 and a light-on/light-off control IC 14 are installed. The rectifier circuit 20 outputs a direct current voltage of 3 to 4.5 V, which is switch-controlled by the control switch 30 to drive the light-on/light-off control IC 14 in each of the color-changing luminous bodies 10. The light-on/light-off control IC 14 controls the individual micro LEDs 12 in each said color-changing luminous body 10, so that the micro LEDs 12 are alternately turned on and off to produce a changing and flickering effect. Now that each of the micro LEDs 12 has a color different from those of the adjacent LEDs, when the light string according to the present invention is put to work by connecting to power and viewed as a whole, a viewer can see a multiple of changing light colors projecting outwards from each of the luminous bodies 10, wherein different colors (such as, for example, red, yellow, blue, green, etc.) show up by turns. In addition, because the individual micro LEDs 12 are controlled by the control switch 30 and the corresponding light-on/light-off control IC 14, a predetermined number of the micro LEDs can be turned on and off individually or in groups, thereby generating a delayed and overlapped lighting effect. As a result, each of the luminous bodies 10 can produce a novel and beautiful color-mixing effect (for example, a red light and a blue light can be mixed to produce a violet light). With the ingenious use of color-changing luminous bodies 10 in the entire light string according to the present invention, the resulting variety of color lights and unpredictable changes of flickering colors upend the traditional lighting effects of conventional light strings, significantly enhance the esthetics of light strings, and contribute to better atmosphere creation.

Furthermore, because a single color-changing luminous body 10 according to the present invention can replace four or more traditional light bulbs or LEDs, the number of lights and the amount of wire material used in an entire set of light decorations can be reduced, so that cost is lowered, electricity is saved, and processing steps are minimized. In addition, a light string may also be moderately downsized so as to be more conveniently hung on a wider variety of objects, effectively broadening the application of light strings.

In summary, the present invention provides an ingeniously designed, novel structure wherein a plurality of color lights and a light-on/light-off control mechanism are integrated into a single color-changing luminous body, and a plurality of such luminous bodies are ingeniously connected in series. The plentiful changes of color lights in each of the color-changing luminous bodies greatly improve the esthetics of the entire light string. In contrast to conventional light strings, the light string according to the present invention meets the requirements of novelty, non-obviousness and usefulness for utility patent application, and therefore, an application for utility patent of the present invention is now filed for examination.

1. (canceled)

2. A color-changing light string assembly comprising:
a plurality of luminous bodies connected together by an electrical line, each of said plurality of luminous bodies comprising:
a transparent enclosure;
a plurality of micro light-emitting diodes positioned in said transparent enclosure so as to direct light outwardly of said transparent enclosure, said plurality of micro light-emitting diodes being of different colors;
a variable resistor connected to each of said plurality of micro light-emitting diodes; and
an integrated circuit means connected to each of said plurality of light-emitting diodes for selectively turning each of said plurality of micro light-emitting diodes on or off;
a rectifying means connected to said electrical line, said rectifying means for outputting a direct current voltage of between 3 and 4.5 volts inclusive; and
a controlling switch means connected to said electrical line to said plurality of light-emitting diodes, said controlling switch means for switch controlling said rectifying means so as to drive said integrated circuit means of each of said plurality of light-emitting diodes of said plurality of luminous bodies.
